(19) United States
(12) Patent Application Publication
(10) Pub. No.: US 2009/0048016 A1
(43) Pub. Date: Feb. 19, 2009

(54) DISPLAY DESIGNED FOR PS3 GAMING MACHINE

(76) Inventor: Juen-Tien Peng, Chung Li Ind. Zone (TW)

Correspondence Address: HDSL, P.O. BOX 220746, CHANTILLY, VA, 20153-0746, US

(21) Appl. No.: 11/839,998

(22) Filed: Aug. 16, 2007

(51) Int. Cl. A63F 13/08

(52) U.S. Cl. 463/31

(57) ABSTRACT

A display designed for a PS3 gaming machine includes a display main unit and a base under the display main unit. The base is specially designed to accommodate a curving structure of a PS3 gaming machine and contains the PS3 gaming machine within space under the base. In addition, two long-shaped straps are disposed on a left and a right side of the base for fixing the PS3 gaming machine and effectively integrating the display main unit and the PS3 gaming machine without using additional tools, providing convenience for a user to carry and store the display and to enjoy the audio and video entertainment brought by the PS3 gaming machine at any place on any time.

### BACKGROUND

1. Field of the Invention

The present invention relates to a display structure, and more particularly, to a display specifically designed for a PS3 gaming machine.

2. Description of Related Art

A gaming machine is an entertainment tool specifically to be used for gaming. It is not only popular among children and young people but also enjoyed by many adults with a huge market. Along with the warming up of global economy in recent years and the continuing development of software and hardware technologies related to gaming, there is a continuous increase in market demand and all kinds of novel gaming machines have come into place.

For gaming machines of the new generation, most attention from the market has been drawn to the ones introduced by Microsoft, Sony, and Nintendo. These machines have broken borders between gaming, home entertainment and internet, and evolved into digital home entertainment machines. PlayStation 3 (PS3) gaming machine introduced by SONY has a complete set of video and audio functions. Besides watching movies and listening to music, a PS3 gaming machine is used for reading relatively high resolution blue laser disk, opening a door to broadband digital home entertainment of the new age and having become a new tool for transmitting games, music, movies and information online. In addition, a PS3 gaming machine has a small size and good feel of quality so that it is carried to all kinds of places and it is easier to use such machine to enjoy games and watch DVD videos than gaming machines of older generations.

However, the main unit of a PS3 gaming machine cannot be used alone and it has to be used with a TV display or a computer display. Although the size of gaming machines has been miniaturized, users, confined by displays, still cannot enjoy the video and audio entertainment provided by the gaming machines as they wish. On the other hand, PS3 gaming machines have a curved shape, which makes it hard to install a display to a PS3 gaming machine and hence greatly limits the application of PS3 gaming machines.

### BRIEF SUMMARY

The present invention provides a display designed specifically for a PS3 gaming machine using a strap to fix a display main unit onto the PS3 gaming machine for alleviating the difficulty of fixing a display on a PS3 gaming machine and facilitating users enjoying audio and video entertainment provided by the PS3 machine on anytime at any place.

In another aspect, the present invention provides a display designed specifically for a PS3 gaming machine which is easily buckled and fixed (with the PS3 gaming machine) without additional tools and is very easy to use.

The present invention provides a display specifically designed for a PS3 gaming machine. The display includes a base and a display main unit. The base easily contains the PS3 gaming machine within space under the base by a curving design of the base. In addition, two long-shaped straps are disposed on a left and a right side of the base for fixing the display main unit by the straps with simple installation so that the display main unit is fixed on the PS3 gaming machine by the base without using additional tools. Moreover, because a front side of the PS3 gaming machine has a concave groove, the two straps are disposed on two sides of a front end of the base for effectively integrating the display main unit and the PS3 gaming machine. The present invention solves the problem that it is hard to install a display on a PS3 gaming machine. The display specifically designed for a PS3 gaming machine has a simple structure, is easy to install and store, does not take excessive space, and facilitates users enjoying audio and video entertainment provided by the PS3 machine on anytime at any place.

Other advantages and novel features will be drawn from the following detailed description of a preferred embodiment.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 is a schematic view of a display specifically designed for a PS3 gaming machine in accordance with a preferred embodiment of the present invention;

FIG. 2A and FIG. 2B are magnified views of a strap in a display specifically designed for a PS3 gaming machine in accordance with a preferred embodiment of the present invention;

FIG. 3A and FIG. 3B respectively illustrate a display specifically designed for a PS3 gaming machine in combination with a PS3 gaming machine in an open and a closed condition in accordance with a preferred embodiment of the present invention.

### DETAILED DESCRIPTION

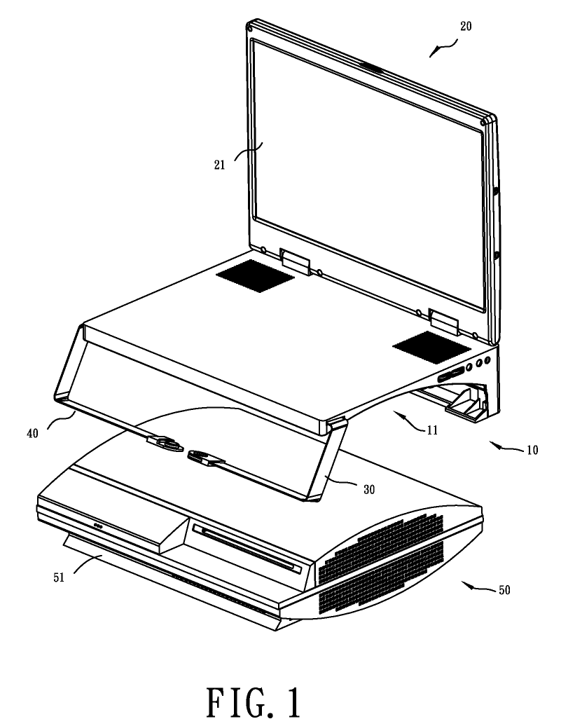

Referring to FIG. 1, the figure depicts a schematic view of a display specifically designed for a PS3 gaming machine in accordance with a preferred embodiment of the present invention. As shown in the figure, the display specifically designed for a PS3 gaming machine in this preferred embodiment comprises a base 10 and a display main unit 20, in which the base 10 is disposed under the display main unit 20. The display main unit 20 is pivotally disposed on the base 10 and readably opened and closed on the base 10. An image surface 21 of the display main unit 20 is disposed on a side facing the base 10. The image surface 21 is configured to close while facing the base 10 for preventing the image surface 21 from damage. In this embodiment, accommodating a curved shape of a PS3 gaming machine, the base 10 is shaped into having a concave surface being able to engage with the convex top surface of the PS3 gaming machine 50, and having an opening space extending around the base 10 for containing the PS3 gaming machine 50. A back side of the base 10 extends and wraps around a back side of the PS3 gaming machine 50, limiting any movement of the PS3 gaming machine in a left and a right direction. To work with the concave groove 51 on the front end of the PS3 gaming machine 50, two long-shaped straps 30 and 40, which are buckled with each other, are disposed respectively on a left and a right side of the front end of the base 10. By using the straps 30 and 40 to buckle the concave groove 51 on the front end of the PS3 gaming machine 50, the space for any movement of the PS3 gaming machine 50 in a forward, a backward or a vertical direction is limited and thereby the whole PS3 gaming machine is fixed under the base.

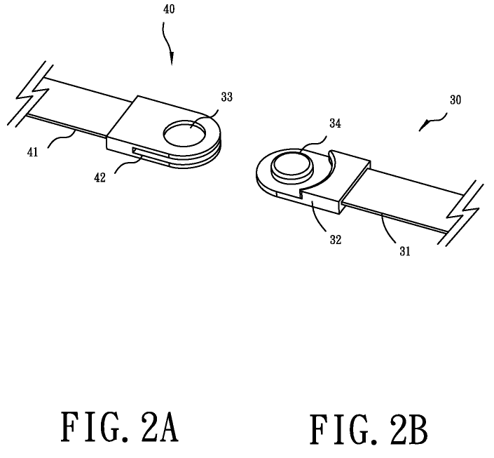

In this embodiment, referring to FIG. 2A and FIG. 2B, magnified views of the straps 30 and 40, the straps 30 and 40 respectively comprise elastic bands 31 and 41 made from elastic materials, and buckles 32 and 42 disposed on front ends of the elastic band 31 and 41. In this embodiment, the elastic bands 31 and 41 of the straps 30 and 40 are made of Nylon. The buckles 32 and 42 are a male buckle and a female buckle respectively. The male buckle 32 has a compressible button 33. The female buckle 42 has a groove 43. The button 33 is pressed into the groove 43 and fixed therein by a pressing action without additional tools, which is very simple.

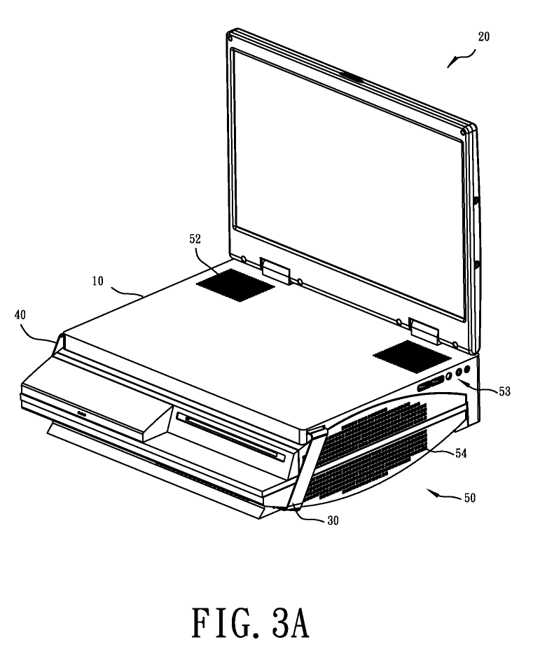

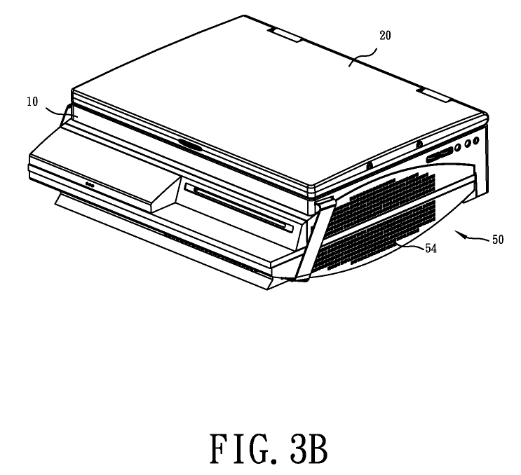

FIG. 3A and FIG. 3B respectively illustrate a display specifically designed for a PS3 gaming machine in combination with a PS3 gaming machine in an open and a closed condition in accordance with the preferred embodiment of the present invention. The present invention provides a display specifically designed for a PS3 gaming machine. The display includes a base 10 accommodating a curving structure of the PS3 gaming machine 50 to contain the same. By using two fixing straps 30 and 40 on the base 10, the display main unit 20 is fixed on the PS3 gaming machine 50 by the base 10. The display has a simple structure and is space saving. In addition, the fixing method required by the display is simple as well, eliminating any need to use additional tools and making the display easy to use. It is hopeful that such displays replace conventional TV or computer displays used with PS3 gaming machines and thereby limitations imposed by space and location of such displays when in use is avoided.

Moreover, in practice, a speaker 52 is disposed on the surface of the base 10 as a result of the combination of the display specifically designed for a PS3 gaming machine and the PS3 gaming machine 50 according to the embodiment. A number of tuning knobs and insert holes are disposed on a side of the base 10 at a user's convenience (as shown in FIG. 3A). In this embodiment, the based is designed not to cover the heat holes 54 of the PS3 gaming machine 50 so that heat dissipation of the PS3 gaming machine is not interfered (as shown in FIG. 3B).

In summary, the present invention provides a display specifically designed for a PS3 gaming machine. The display includes a base accommodating a curving structure of the PS3 gaming machine and straps buckling the PS3 gaming machine, alleviating the difficulty of fixing a display on a PS3 gaming machine and facilitating a user enjoying audio and video entertainment provided by the PS3 machine on all kinds of occasions without using additional TV or computer displays, eliminating the limit by its big volume. So it is very convenient to use for the user.

The above description is given by way of example, and not limitation. Given the above disclosure, one skilled in the art could devise variations that are within the scope and spirit of the invention disclosed herein, including configurations ways of the recessed portions and materials and/or designs of the attaching structures. Further, the various features of the embodiments disclosed herein can be used alone, or in varying combinations with each other and are not intended to be limited to the specific combination described herein. Thus, the scope of the claims is not to be limited by the illustrated embodiments.

What is claimed is:

1. A display designed for a PS (PlayStation) 3 gaming machine with a convex curving surface on the top thereof, comprising:
a display main unit; and
a base, the base contacting a bottom side of the display main unit, a bottom part of the base having a concave curving surface corresponding to the top of the PS3 gaming machine, four sides of the base extending downward and forming an opening space for containing the PS3 gaming machine, two long-shaped straps which buckles with each other being disposed respectively on a left side and a right side of the base for surrounding the PS3 gaming machine and fixing the same.

2. The display designed for a PS3 gaming machine of claim 1, wherein the two straps respectively comprise an elastic band made from elastic materials and a buckle disposed on a front end of the elastic band.

3. The display designed for a PS3 gaming machine of claim 2, wherein the elastic bands of the two straps are made of Nylon.

4. The display designed for a PS3 gaming machine of claim 2, wherein the buckles of the two straps are a male buckle and a female buckle respectively, the male buckle having a compressible button, the female buckle having a groove, the compressible button being able to be pressed into the groove and fixed therein by a pressing action.

5. The display designed for a PS3 gaming machine of claim 1, wherein the display main unit is pivotally disposed on the base and rotatably opened and closed on the base.

6. The display designed for a PS3 gaming machine of claim 5, wherein the display main unit is pivotally disposed on a back side of the base.

7. The display designed for a PS3 gaming machine of claim 1, wherein a side of the display main unit facing the base comprises an image surface, the image surface configured to close while facing the base for protecting the image surface.
